(19) United States
(12) Patent Application Publication
(10) Pub. No.: US 2014/0278907 A1
(43) Pub. Date: Sep. 18, 2014

(54) Rewarding User Generated Content

(71) Applicant: MICROSOFT CORPORATION, Redmond, WA (US)

(72) Inventor: Sandeep Paruchuri, Seattle, WA (US)

(73) Assignee: MICROSOFT CORPORATION, Redmond, WA (US)

(21) Appl. No.: 13/798,305

(22) Filed: Mar. 13, 2013

(51) Int. Cl. G06Q 30/02

(52) U.S. Cl. CPC G06Q 30/0239
USPC 705/14.39

(57) ABSTRACT

Example apparatus and methods concern rewarding a user for making a contribution to a crowd-sourced database. An example apparatus may include logic for acquiring the contribution, where the contribution is data produced by a mobile device concerning a point of interest. The example apparatus also includes logic for producing an evaluation of the contribution and logic for providing a reward based on the contribution, the evaluation, and the user. The contribution may be data about a point of interest. The evaluation may be based on the completeness, timeliness, or contents of the contribution. The reward may be selected based on the evaluation of the contribution and a profile of the user. The reward or user profile may be manipulated based on confirmation or repudiation of the contribution by a different user contribution or by curation of the contribution. Providing the contribution may be free to the user.

### BACKGROUND

Mobile devices like cellular phones are frequently used to search for local points of interest. The quality of the search result depends on the quality of the data available concerning those points of interest. Information concerning points of interest may be gathered in different ways. Conventionally, employees of the search provider may have roamed locations acquiring and inputting data about points of interest. Additionally, crowd-sourced data may also have been acquired and used without filtering, leading to questionable results. For example, stale or even fraudulent data may appear in conventional crowd-sourced data. In general, crowd-sourced refers to obtaining needed services, ideas, or content by soliciting and accepting contributions from a large group of undefined people, particularly from an online community. Crowd-sourced refers to the combined efforts of crowds of volunteers or others who each contribute a small portion that ultimately adds up to a relatively large or significant result.

In both approaches, collecting information about relevant local destinations may have been a challenge, particularly when the local destinations may be highly transient and only semi-documented, if documented at all. Consider a city where a significant portion of the economy involves highly transient street vendors. The street vendors may be transient from season to season depending on what they sell (e.g., fresh fruit), may be transient from day to day depending on what they have available (e.g., fresh catch of the day), may be transient from time-of-day to time-of-day (e.g., hot dog vendor near office building at noon but near baseball stadium in evening), or may be transient for other reasons. These impromptu and semi-official destinations may be an integral part of the consumer landscape and thus relevant to local searches. Large fixed locations (e.g., stadiums) may be easy to find and well documented while small mobile locations (e.g., chai cart) may be more difficult to find and less documented.

Consider also activities that are by necessity transient. For example, a surf board rental van may be positioned where the waves are breaking the best at that moment in time. The break may change from high tide to low tide and as the wind changes direction. All of these types of transient vendors may be the subject of a local search by a user of a mobile device. Conventionally, finding the current location and availability of a relevant vendor or other point of interest using a mobile device that performs a local search may have been difficult, if even possible at all. Points of interest that may be highly transient or for which documentation may be scant or non-existent may be referred to as hyperlocal points of interest (HPOI).

Acquiring timely user generated content concerning HPOI facilitates improving the quality of a local search. Like it is for the fruit or fish vendor, freshness matters to user generated content concerning moving targets like HPOI. Unlike the fruit or fish vendor who has a constant incentive (e.g., sales) to insure their product is fresh, there may be little incentive for potential crowd-sourcers to provide information about HPOI. While some conventional approaches have attempted to incentivize crowd-sourcers to provide user generated content by offering rewards, it may have been more expensive for the crowd-sourcer to provide the information than the generic reward was worth. Additionally, anonymous submissions paid for with anonymous generic rewards may have been prone to fraudulent activity. Furthermore, generic rewards may have been unattractive to potential crowd-sourcers.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods incentivize contributions to an effective crowd-sourced database. The database may store information concerning hyperlocal points of interest (HPOI). To encourage contributions, incentives may be customized for individual registered contributors and may depend on the data provided. To remove barriers to contributing data concerning HPOI, pathways for providing fresh user generated content from a mobile device are configured to be free for the contributor. To encourage the most complete and highest quality contributions, rewards may be based on the quality of data submitted, where quality is measured by different criteria. To mitigate the risk of acquisition fraud, where a user seeks to acquire undeserved rewards by, for example, providing the same information over and over, only registered users may participate in the rewards program and submissions may be tracked on a per registered user basis. In one embodiment, registration may be implicit in another program or network (e.g., social network site). The social network site may be correlated with or integrated into the rewards program. To mitigate the risk of malicious fraud, where a user seeks to provide disinformation (e.g., incorrect location, incorrect operating hours), submissions that are voted down or otherwise invalidated may be used to adjust a trustworthiness rating for a user to indicate the user is less trustworthy. Similarly, to encourage ongoing accurate and complete contributions, submissions that are voted up or otherwise validated may be used to adjust a trustworthiness or “power” ranking for a user to indicate that the user is more trustworthy or more valued. Reward levels may vary based on trustworthiness or value.

Example apparatus may be configured with a custom access point name (APN) that is configured to participate in a custom carrier agreement to insure that contributions from a registered user of a registered device will be free and potentially rewarded. While information concerning HPOI are interesting, information concerning traditional points of interest is also interesting. Therefore, example apparatus and methods may also reward contributions concerning traditional (e.g., static) points of interest. Rewards may include, for example, free prepaid data, credits towards online gaming, or other rewards that are customizable to a user.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example geography that includes hyperlocal points of interest and traditional points of interest.

FIG. 2 illustrates an example data flow associated with rewarding user generated content.

FIG. 3 illustrates an example method associated with rewarding user generated content.

FIG. 4 illustrates an example method associated with rewarding user generated content.

FIG. 5 illustrates an example apparatus configured to participate in rewarding user generated content.

FIG. 6 illustrates an example apparatus configured to participate in rewarding user generated content.

FIG. 7 illustrates an example cloud operating environment.

FIG. 8 is a system diagram depicting an exemplary mobile communication device configured to participate in rewarding user generated content.

### DETAILED DESCRIPTION

Example apparatus and methods facilitate rewarding contributions of user generated content to an effective crowd-sourced database. The user generated content may concern hyperlocal points of interest (HPOI). Example apparatus and methods may also incentive contributions concerning traditional (e.g., static) points of interest. HPOI are characterized by their transient nature, either temporally or spatially. For example, a street vendor may move their cart from location to location depending on the time of day (e.g., lunch, dinner, before game, after game), depending on the time of year (e.g., shady location in summer, sunny location in winter), depending on local conditions (e.g., covered location while raining, open location while sunny), depending on their product (e.g., fruit, fish, hot dogs, hats), or depending on other factors. Traditional points of interest are characterized by their static nature, both temporally and spatially. For example, a store may be in the same physical location providing the same goods or services with the same operating hours for years.

To encourage contributions, incentives may be customized for individual registered contributors. Contributors may be registered based, for example, on an identity associated with their mobile device. In one embodiment, contributors may be able to select a reward towards which they would like to work. As the contributor provides data, and as that data is voted up, confirmed, successfully curated, or otherwise validated, the contributor may make progress toward the reward. In another embodiment, rewards may be selected based on contributor profiles. For example, contributors with high data usage may be offered prepaid data or discounted data for their mobile device. Similarly, for contributors who are garners, unique game items or screens may be made available. Likewise, for contributors who are shoppers, targeted coupons or other discounts may be made available.

To encourage the most complete and highest quality contributions, rewards may be based on the quality of data submitted, where quality is measured by different criteria. One criteria by which quality may be measured is the completeness of the data provided. For example, if 100% of the data necessary for a complete HPOI record is provided, the user may receive 100% of a reward. The reward may be proportional to the amount of data provided. For example, if only half the data necessary for a complete HPOI record is provided, the user may only receive 50% of a reward. The amount of the reward may be a function (e.g., linear, non-linear) of the amount or quality of data provided. For example, the reward may grow exponentially as the amount or quality of data increases.

Another criteria by which quality may be measured is the type of data provided. For example, a photograph tagged with GPS co-ordinates may be considered more valuable than a simple text description. Thus, a GPS tagged photograph contribution may receive a larger reward than a simple text description.

Another criteria by which quality may be measured is the subsequent treatment of the contribution. If the contribution is voted up, then the reward may be increased. Voting up involves subsequent viewers of the HPOI record associated with the contribution indicating that they “like” or “approve” or otherwise have gained value from the HPOI record. If the contribution is voted down, then the reward may not be increased. Voting down involves subsequent viewers of the HPOI record indicating they “disliked” or “disapproved” or otherwise did not gain value from the HPOI record. Subsequent treatment may also include receiving similar or matching contributions concerning the HPOI. When two or more contributors provide similar contributions about the same HPOI in a relevant time frame (e.g., within an hour, within a day), then it may be more likely that the contributions are accurate. More accurate data may be treated as higher quality data and a reward may be increased. Subsequent treatment may also include receiving dissimilar or conflicting contributions concerning the HPOI. When there are conflicting contributions, then the data may be treated as lower quality data and the reward may not be increased or even provided at all.

Another criteria by which quality may be measured is timeliness. For example, the first discovery of an HPOI may be considered more valuable than a subsequent confirmation of the HPOI. The second discovery may yield a lesser reward and subsequent “discoveries” may receive even lesser rewards. However, second and subsequent “discoveries” are still useful for completing, confirming, and validating an initial discovery. Therefore, in one embodiment, rewards may still be provided no matter how many times the HPOI is “discovered.”

Contributions concerning both HPOI and traditional points of interest are to be encouraged. In one embodiment, different rewards may be provided for different types of data. For example, rewards may be provided in increasing amounts for confirmations of traditional points of interest, confirmations of HPOI, early discoveries of HPOI, early discoveries of traditional points of interest, completions of HPOI, completions of traditional points of interest, first discovery or HPOI, and first discovery of a traditional point of interest. Different scales may be employed in different examples.

To mitigate the risk of acquisition fraud, where a user seeks to acquire undeserved rewards by, for example, providing the same information over and over, registration may be employed. Users will register for the rewards program and submissions may be tracked on a per registered user basis. If a user submits the same contribution within a time window, then only the first submission may be rewarded and subsequent submissions may negatively impact a trustworthiness rating of the user or a fraud alert rating of the user. However, cases may arise where it is valuable to have a user submit the same contribution over and over. For example, it may be valuable to have the same user input the location of the same fruit vendor cart every day. In this case the user is providing a valuable and non-fraudulent service. However, if the user submits the same record ten times in one minute, this is not useful and may be fraudulent. Therefore, evaluating repeat submissions may involve evaluating the time period or interval over which the submissions are made. Unlike anonymous systems, where it may be difficult to track repeated submissions, example apparatus and methods will allow users to voluntarily register their device or account with the rewards service.

To mitigate the risk of malicious fraud, where a user seeks to provide disinformation (e.g., incorrect location, incorrect operating hours), submissions that are voted down or otherwise invalidated may be used to adjust down a trustworthiness rating for a user or to negatively impact a fraud alert rating for the user. Malicious fraud may be intended to mislead potential consumers about the location or availability of a vendor. For example, one street vendor may want to report that a competitor street vendor is in a different location or has a different price or product than is actually the case. These types of potentially fraudulent submissions may not be rewarded and may lead to other action being taken against the registered user.

To encourage ongoing accurate and complete contributions, submissions that are voted up or otherwise validated may be used to adjust up a trustworthiness or “power” ranking for a user. For example, a user that consistently provides submissions that are either confirming another submission or that are consistently confirmed may be notified that they are being moved to a higher reward level. The higher reward level may make more valuable, different, or unique rewards available. To encourage consistency, the higher reward level may be a temporary ranking that can be maintained by providing a threshold number of submissions that meet a quality criteria within a threshold period of time. For example, two high quality submissions per week may maintain the user's higher reward level.

To remove barriers to contributing, pathways for providing fresh user generated content from a mobile device are configured to be free for the contributor. Example apparatus may be configured with a custom access point name (APN) that is configured to participate in a custom carrier agreement to insure that contributions from a registered user of the registered device will be free and potentially rewarded.

An Access Point Name (APN) is the name of a gateway between a General Packet Radio Service (GPRS) mobile network or other service/network and another computer network (e.g., Internet). GPRS usage or other service/network usage is typically charged based on the volume of data transferred. A mobile device (e.g., cellular phone) making a data connection may be configured with an APN to present to the carrier. The carrier may examine the APN to determine what type of network connection to create and how to charge for the connection and data transfers. Example apparatus may include a custom APN that allows the user to contribute user generated content for free. An APN may identify the packet data network (PDN) to which a mobile data user wants to communicate. While APNs are used in third generation protocols, similar identifiers may be used in other generation protocols. Regardless of the generation of the protocol or device, example apparatus and methods may provide a transparent connection and identifier that facilitate insuring that the user will not be billed for making the contribution.

Different users may be rewarded with different types of rewards. Rewards may include, for example, free prepaid data, credits towards online gaming, or other rewards that are customizable to a user. Rewards may be customized for a user. For example, a user who is a gamer may be offered the opportunity to acquire a unique weapon or to participate in a unique battlefield. Similarly, a user who routinely shops in a certain store may receive coupons for that store. In one embodiment, a user may be allowed to identify the reward they would like to receive. In this way, long term behavior may be influenced as the user works towards their identified reward by providing a threshold number, type, and quality of contributions associated with acquiring the reward.

In one embodiment, a user may designate a recipient for their reward. For example, a parent may designate a child as the recipient of rewards that are targeted towards a game that the child plays. In another example, a user may designate a charity as the recipient of credits for contributions. For example, instead of receiving a personal reward for making a contribution, a user may designate that an equivalent cash or in-kind reward be made to a charity. Thus, contributions that may result in seemingly insignificant rewards for a single user, when aggregated by a community of contributors, may produce a significant aggregate contribution. For example, a group of students at a school may donate their rewards to a book purchase program at their school to achieve collectively what they may not be able to achieve individually.

The following use cases illustrate different ways in which example systems and methods may incentivize and reward crowd-sourcers to provide user generated content that may improve local searches for traditional or hyperlocal points of interest. Sameera may be walking home from the bus stop when she notices that her favorite local stores and restaurants are not in her phone's database. She goes to “check in” on her phone, but discovers there is no check in possible for the location. She taps “add” on her crowd-sourcing application and adds basic venue information for the traditional point of interest. The information may include the name and location of the point of interest. Little information other than the name and location may be required for a big chain store or restaurant because other viewers are likely to know the established chain by name and reputation. After adding the data, she submits the entry to create the destination. Once it has been added, she may post her visit to her social network(s). Example apparatus and methods may later notify her that when the venue is approved she will receive a reward (e.g., 10 MB data credit on her next bill).

Later, Sameera may pass by her favorite street vendor who happens to have fresh coconut water. While waiting in line for her coconut, she may open her crowd-sourcing application and add information for the hyperlocal point of interest. The information may include what is being sold, a comment on the quality of the item being sold, her thoughts about how frequently the vendor is in this location, her thoughts about the times the vendor is in this location, or other subjective information. After adding the data, she submits the entry to create the hyperlocal point of interest. Once again she may post to her social network about being at the point of interest. Example apparatus and methods may later notify her that because she was the first to report this vendor she will receive a credit of 2 MB of data for her contribution. Or, if she was not the first to report this vendor, she may be notified that she will be credited with 1 MB of data for confirming someone else's discovery.

Rajeev may be on his way home from a friend's house. His mother may text him to bring home some mangoes. Rajeev may know where a permanent grocery store is located but may also know that during this time of year the best mangoes are found at street vendors. He may open a local search application on his smart phone and be presented with hyperlocal points of interest. He may notice that one HPOI was posted by his friend just a half hour earlier and thus may visit that vendor. Rajeev may confirm his friend's post after picking out ripe mangoes. Rajeev may be rewarded for confirming his friend's post and his friend may receive an enhanced reward for having his post confirmed. The confirmation of the post may cause the HPOI to be ranked higher in a subsequent search. Confirmation of a post may occur in different ways. For example, confirmation could be determined by a connected call, navigation to a destination, time spent at destination, or in other implicit ways that do not require an explicit user vote.

Later, Rajeev may be on his way to the movie and he may be hungry. Since he's already spent nearly all his money, he's looking for an affordable street-side vendor to get a snack rather than paying the concession stand prices at the theater. Once again Rajeev may open his local search application and be presented with relevant hyperlocal points of interest. In this case, Rajeev may not feel like he has time to check in at the HPOI. However, the local search application may determine that data associated with the HPOI is in a state where a confirmation or repudiation would be useful for the local search application. For example, the local search application may be aware that there have been two unconfirmed contributions in the area where Rajeev is looking. Therefore, the application may provide Rajeev with a reminder that submitting information about the HPOI is free and may be accompanied by a reward. The reminder and incentive may lead Rajeev to spend the few extra seconds to confirm or repudiate the information about the HPOI. In one embodiment, the reminder may be presented without evaluating the state of the data.

While the above use case scenarios deal with “locals”, other use case scenarios may involve travelers or tourists. For example, a tourist in a foreign country may have no local knowledge about the location or quality of vendors. In some situations, it may be undesirable to question passersby in an attempt to acquire local knowledge. In other situations, it may be impossible to question locals because of language barriers. Therefore, in an attempt to “live like a local”, the traveler may employ a local search application. Local vendors may be incentivized to keep their information current and therefore may provide a data set about their own HPOI. Travelers or tourists may then be able to access the HPOI and to confirm or repudiate its value. The vendor may benefit by sales to tourists and may also receive an incentive from example apparatus or systems. The tourists may benefit from receiving accurate up-to-date information without be required to speak the local language or to expose their lack of knowledge. The tourists may also be rewarded by example apparatus or systems. In one embodiment, the tourists may establish their travel profile to donate rewards to local charities.

FIG. 1 illustrates an example geography that includes hyperlocal points of interest and traditional points of interest. An office building 100 may be located in one part of a city and a theatre 130 and a stadium 140 may be located in other parts of the city. At a first time of day (e.g., lunchtime), a first street vendor 110 and a second street vendor 120 may position their carts near the office building 100. At a second time of day (e.g., after work), the first street vendor 110 may reposition his cart near the theatre 130 while the second street vendor 120 may reposition her cart near the stadium 140. The office building 100, the theater 130, and the stadium 140 may be considered to be permanent, traditional, or fixed points of interest. The two street vendors may be considered to be hyperlocal points of interest.

FIG. 2 illustrates an example data flow associated with rewarding user generated content. A user may have a mobile device 200. The user may generate content that is provided from the mobile device 200 to a reward service 210 as a point of interest data set 220. The reward service 210 may evaluate the point of interest data set 220 using an evaluator 240. A rewarder 250 may determine a reward to provide to the user of the mobile device 200 based on the point of interest data set 220, the evaluation of the point of interest data set 220, and the user of the mobile device 200. The reward service 210 may provide a reward or notification of reward 230 to the mobile device 200. The reward service 210 may selectively curate (e.g., authenticate, validate, store, maintain) the point of interest data set 220 using a curator 260. The reward service 210 may store data in a database 270 or may retrieve data from database 270.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

FIG. 3 illustrates an example method 300 associated with rewarding user generated content. In different examples, method 300 may be performed on a single device, may be performed partially or completely in the cloud, may be performed on distributed co-operating devices, or may be performed other ways. In different examples, method 300 may be performed on devices including, but not limited to, a computer, a laptop computer, a tablet computer, a phone, and a smart phone.

Method 300 includes, at 320, receiving user generated content. The user generated content may be received from a mobile device. The user generated content may include a point of interest data set suitable for storing on a computer-readable storage medium. In one example, the point of interest data set may include information concerning a hyperlocal point of interest. The information concerning the hyperlocal point of interest may include, but is not limited to include, a type of business, a type of product (e.g., fruit, fish), a type of service, a location, a photograph, a comment, a rating, or an availability. In one embodiment, the location may be provided with reference to a traditional or fixed point of interest (e.g., in front of theater). In one embodiment, the point of interest data set may include information concerning a traditional point of interest. The information concerning the traditional point of interest may include, but is not limited to include, a name, an address, a photograph, a comment, a link, or a rating. In one embodiment, the point of interest data set may include an identifier of the user who provided the user generated content. The identifier is configured to identify the user as a voluntarily registered participant in a rewards program and to provide access to a profile of the user. Having the user identifier facilitates customizing a reward for that individual user.

Method 300 also includes, at 330, establishing a quality measure for the point of interest data set. In one example, establishing the quality measure includes evaluating a completeness of the point of interest data set. For example, a complete point of interest (POI) data set may include ten fields. An incoming POI data set may have less than all ten fields. A reward level may be directly proportional to the completeness of the incoming POI data set. Establishing the quality measure may also include evaluating a type of data provided in the point of interest data set. For example, a POI data set may have fields for photographs, text descriptions, location information, and other fields. Some fields may be considered to be more valuable than other fields, and some combinations of fields may be considered to be more valuable than other combinations. Therefore, a reward level may be determined, at least in part, by which fields or combinations of fields are provided. Establishing the quality measure may also include examining a profile of the user. Data received from a user who consistently provides high quality data may be considered to be of a higher quality than data received from a user who rarely provides high quality data. Additionally, a confirmation of data may also be evaluated in light of the historical performance of the user confirming the data. Establishing the quality measure may also include evaluating a similarity of the point of interest data set to a previously acquired data set. For example, if an incoming POI data set matches a previously validated but expired POI data set, the incoming POI data set may be deemed to have a higher quality. But if an incoming POI data set contradicts a previously validated POI data set, the incoming POI data set may be deemed to have a lower quality.

In one embodiment, establishing the quality measure may include evaluating subsequent treatment of the point of interest data set. In this embodiment, selection and provision of a reward may be delayed until a threshold amount of subsequent activity is detected. For example, a reward may not be selected or provided until a subsequent high quality confirmation is received. Evaluating subsequent treatment of the point of interest data set may include evaluating whether the point of interest data set was voted up or was voted down. Confirming votes may raise the quality level of data and dismissing votes may lower the quality level of data. Evaluating subsequent treatment may include determining whether the point of interest data set was validated or invalidated. Validation may include identifying whether the type of point of interest submitted is possible in the location. For example, it may not be possible for a new restaurant to appear at the same GPS coordinates currently occupied by another validated, confirmed restaurant. Data that was validated may receive a higher quality measure while data that was invalidated may receive a lower quality measure. Evaluating subsequent treatment may also include determining whether the point of interest data set was confirmed. Confirmation may include receiving similar data from a subsequent discoverer of the point of interest.

Method 300 also includes, at 340, selectively curating the point of interest data set. The point of interest data set may be curated upon determining that the quality measure exceeds a quality threshold. In one example, curating the point of interest data set may include authenticating a member of the point of interest data set against a set of authentication criteria, validating a member of the point of interest data set against a set of validation criteria, or selectively archiving the point of interest data set. Curating the data set may also include selectively updating a point of interest data store with the point of interest data set. Updating the point of interest data store makes the point of interest data set available to an application that accesses the point of interest data store. Example apparatus and methods may seek to accelerate or even bypass curation in an attempt to balance freshness of data against accuracy of data. When the quality of incoming user generated content exceeds a quality measurement based, for example, on recent subsequent treatment (e.g., confirmation) of data received from a user who consistently provides high quality data, curation may be bypassed.

Method 300 also includes, at 350, selecting a reward to provide to a user of the mobile device. The reward may be selected as a function of an attribute of the point of interest data set, the quality measure, and an attribute of the user. The reward may take different forms. For example, the reward may be a data award, a gaming reward, a shopping reward, a marketplace reward, a downloadable content award, or an affinity reward. A data award may be, for example, a credit on a data plan associated with the mobile device. A gaming reward may be, for example, access to a special screen, weapon, or character. A shopping reward may be, for example, a discount coupon. A marketplace reward may be, for example, a credit in a market where the user shops. A downloadable content reward may be, for example, a free download (e.g., song, article, video). An affinity reward may be, for example, frequent flier miles. The reward may be customized to the user based on different factors. For example, a user may receive a first customized reward when they are in a first location but may receive a second, different customized reward when they are in a second location. Additionally, a user may receive one type of gaming reward based on recent game play or may receive a different type of reward based on recent downloads. For example, if a user has spent more than a threshold amount of time playing a certain game, the user may receive rewards tailored for that game. But if a user has spent more than a threshold amount of time listening to music by a certain artist, the user may receive rewards associated with that artist. Since the rewards program is a voluntary and free program, only the information specifically identified by the user as being able to be considered for reward customization may be available to the reward selector.

Method 300 also includes, at 360, selectively providing the reward to the user. In one example, providing the reward to the user includes providing the reward to the user or to a rewardee identified by the user. Providing the reward may include pushing content to a mobile device used by the user. Providing the reward may also include, for example, adding credits to an account associated with the user.

FIG. 4 illustrates an example method 400 associated with rewarding user generated content. Method 400 includes several actions (e.g., receiving point of interest data set at 420, establishing a quality measure at 430, selectively curating data at 440, selecting a reward at 450) similar to method 300 (FIG. 3). However, method 400 also includes additional actions.

Method 400 also includes, at 410, selectively providing a notice to the user that providing the point of interest data set will be free or providing a notice to the user that providing a point of interest data set may provide a reward. The notice may be a display on a screen, a text message, a voice message, an audible reminder, a visible reminder, or other notice. The notice(s) may be provided, for example, upon detecting that the user is at a potential point of interest or upon detecting that the user is interacting with an application that accesses point of interest data. Detecting that a user is at a potential point of interest may include comparing current position data associated with the mobile device to position data associated with previously acquired point of interest data sets. Detecting that the user is interacting with an application that accesses point of interest data may include identifying a user interaction with a mapping application, with a social media application, or other application.

Method 400 also includes, at 470, selectively updating a user profile associated with the user. The profile may be updated as a function of a subsequent treatment of the point of interest data set or as a function of curating the point of interest data set. For example, subsequent positive treatment where the data is confirmed or validated may lead to updating the user profile to reflect the positive treatment. Similarly, subsequent negative treatment where the data is rejected or invalidated may lead to updating the user profile to reflect the negative treatment. Selectively updating the user profile may include manipulating a trustworthiness rating for the user or manipulating a reward level for the user. Manipulating a rating may include writing a value to an in-memory variable, writing a value to a record, writing a value to a table, or other data manipulation. Reward levels may be determined, at least in part, by a user profile. Additionally, quality measurements may be determined, at least in part, by a user profile.

While FIGS. 3 and 4 illustrate various actions occurring in serial, it is to be appreciated that various actions illustrated in FIGS. 3 and 4 could occur substantially in parallel. By way of illustration, a first process could acquire point of interest data, a second process could process the point of interest data, a third process could identify rewards, and a fourth process could curate point of interest data. While four processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 300 or 400. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

FIG. 5 illustrates an apparatus 500 that includes a processor 510, a memory 520, a set 530 of logics, and an interface 540 that connects the processor 510, the memory 520, and the set 530 of logics. The set 530 of logics may be configured to facilitate rewarding user generated content that satisfies a quality threshold. Apparatus 500 may be, for example, a computer, a laptop computer, a tablet computer, a personal electronic device, a smart phone, or other device that can access and process data.

In one embodiment, the apparatus 500 may be a general purpose computer that has been transformed into a special purpose computer through the inclusion of the set 530 of logics. The set 530 of logics may be configured to reward a user for making a contribution of user generated content to a crowd-sourced database. Apparatus 500 may interact with other apparatus, processes, and services through, for example, a computer network.

The set 530 of logics may include a first logic 532 that is configured to acquire the contribution from the user. The contribution may be data produced by a mobile device. The contribution may be data concerning a point of interest. The data will be suitable for storage on a computer-readable storage medium. The human mind is incapable of processing this type of data. Similarly, this type of data cannot be processed by pencil or paper. The contribution may be received by a computer or network communication.

In one embodiment, the first logic 532 may be configured to acquire the contribution as data concerning a transient point of interest or a fixed point of interest. The data concerning the transient point of interest may include information tailored to the transient or undocumented nature of a hyperlocal point of interest. For example, the information may include a location of the transient point of interest and an activity associated with the transient point of interest. The data concerning the fixed point of interest may include information tailored to the fixed or documented nature of a traditional point of interest. For example, the information may include a name and an address of the fixed point of interest.

The set 530 of logics may also include a second logic 534 that is configured to produce an evaluation of the contribution. In one embodiment, the second logic 534 may be configured to produce the evaluation of the contribution based on the completeness of the contribution, the timeliness of the contribution, the contents of the contribution, and the similarity of the contribution to an existing contribution. By way of illustration, a contribution that is more complete may receive a higher evaluation than a contribution that is less complete. Timeliness concerns whether a contribution is a first (e.g., discovery) notice of a point of interest or a subsequent (e.g., confirmation) notice of a point of interest. First discoveries may be rewarded at a higher level than subsequent confirmations. The contents of the contribution may also contribute to the evaluation. For example, an annotated picture of the fish being sold at a roadside stand may produce a higher evaluation than a text description of the fish. The similarity of the contribution facilitates determining whether the fresh data is accurate. When two or more different users provide similar information within a threshold period of time, the information concerning point of interest may be considered more reliable.

The set 530 of logics may also include a third logic 536 that is configured to provide a reward based on the contribution, the evaluation, and the user. In one embodiment, the third logic 536 may be configured to provide the reward based on the evaluation of the contribution and a profile of the user. For example, larger rewards may be provided to a consistent user who has provided a complete and confirmed contribution while lesser rewards may be provided to an occasional user who provides an incomplete and unconfirmed contribution. Different schemes may be employed at different times to encourage different behaviors. For example, substantial rewards may be offered to first time users or to new users in an attempt to increase the number of participants in the user generated content rewards program.

The third logic 536 may also be configured to update the profile of the user based on confirmation or repudiation of the contribution. When contributions from a user are confirmed by other users, the user may receive an improved rating. When contributions from a user are repudiated or rejected by other users, the user may receive a diminished rating. Quality determinations and reward selections may be based, at least in part, on a user profile.

In different embodiments, some processing may be performed on the apparatus 500 and some processing may be performed by an external service or apparatus. Thus, in one embodiment, apparatus 500 may also include a communication circuit that is configured to communicate with an external source to facilitate displaying point of interest data or reward notifications. In one embodiment, the third logic 536 may interact with a presentation service 560 to facilitate displaying data using different presentations for different devices. For example, the graphics quality of a reward notification may be tailored to the type of device to which the reward notification is being provided. Additionally, the presentation service 560 may localize a reward notification. Localizing the reward notification may include, for example, translating the notification to a language associated with the user of the mobile device.

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. The fourth logic 638 may be configured to notify the user that making a contribution is free and to notify the user that making a contribution may generate a reward. The notification may take forms including, but not limited to, a visual notice, an audible notice, or other notice.

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example reward service 760 residing in the cloud. The reward service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the reward service 760.

FIG. 7 illustrates various devices accessing the reward service 760 in the cloud. The devices include a computer 710, a tablet 720, a laptop computer 730, a personal digital assistant 740, and a mobile device (e.g., cellular phone, satellite phone) 750. The reward service 760 may evaluate user generated content, select a reward, and produce a notification of reward, among other actions.

It is possible that different users at different locations using different devices may access the reward service 760 through different networks or interfaces. In one example, the reward service 760 may be accessed by a mobile device 750. In another example, portions of reward service 760 may reside on a mobile device 750.

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include web pages, text, images, sound files, video data, or other data sets to be sent to or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN).

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added. For example, a near field communication (NFC) component 892 may facilitate exchanging digital content, making transactions, or connecting devices through a touch. Thus, in one embodiment, an interaction with a pay terminal at an HPOI could trigger HPOI data acquisition and entry.

Mobile device 800 may include a reward logic 899 that is configured to provide a functionality for the mobile device 800. For example, reward logic 899 may provide a client for interacting with a service (e.g., service 760, FIG. 7). Portions of the example methods described herein may be performed by reward logic 899. Similarly, reward logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving, from a mobile device, user generated content comprising a point of interest data set, where the point of interest data set is suitable for storing on a computer-readable storage medium;
establishing a quality measure for the point of interest data set;
upon determining that the quality measure exceeds a quality threshold:
selectively curating the point of interest data, and
selecting a reward to provide to a user of the mobile device as a function of an attribute of the point of interest data set, the quality measure, and an attribute of the user;
and
selectively providing the reward to the user.

2. The method of claim 1, where establishing the quality measure includes evaluating a completeness of the point of interest data set, evaluating a type of data provided in the point of interest data set, or examining a profile of the user.

3. The method of claim 1, where establishing the quality measure includes evaluating a similarity of the point of interest data set to a previously acquired data set.

4. The method of claim 1, where establishing the quality measure includes evaluating subsequent treatment of the point of interest data set, where evaluating subsequent treatment of the point of interest data set includes evaluating whether the point of interest data set was voted up, evaluating whether the point of interest data set was voted down, evaluating whether the point of interest data set was validated, evaluating whether the point of interest data set was invalidated, or evaluating whether the point of interest data set was confirmed.

5. The method of claim 1, comprising selectively updating a point of interest data store with the point of interest data set, where selectively updating the point of interest data store makes the point of interest data set available to an application that accesses the point of interest data store.

6. The method of claim 1, where curating the point of interest data set comprises authenticating a member of the point of interest data set against a set of authentication criteria, validating a member of the point of interest data set against a set of validation criteria, or selectively archiving the point of interest data set.

7. The method of claim 1, where the point of interest data set includes information concerning a hyperlocal point of interest, and where the information concerning the hyperlocal point of interest includes a type of business, a type of product, a type of service, a location, a photograph, a comment, a rating, or an availability.

8. The method of claim 1, where the point of interest data set includes information concerning a traditional point of interest, and where the information concerning the traditional point of interest includes a name, an address, a photograph, a comment, a link, or a rating.

9. The method of claim 1, where the point of interest data set includes an identifier of the user, where the identifier is configured to identify the user as a voluntarily registered participant in a rewards program and to provide access to a profile of the user, or where the identifier identifies the user as a member of a social network with which the rewards program is correlated.

10. The method of claim 1, where providing the reward to the user includes providing the reward to the user or to a rewardee identified by the user.

11. The method of claim 1, where the reward is a cellular data reward, a data plan reward, a gaming reward, a shopping reward, a marketplace reward, a downloadable content award, or an affinity reward.

12. The method of claim 1, comprising:
selectively updating a user profile associated with the user as a function of a subsequent treatment of the point of interest data set or as a function of curating the point of interest data set, where selectively updating the user profile includes manipulating a trustworthiness rating for the user or manipulating a reward level for the user.

13. The method of claim 1, comprising:
upon detecting that the user is at a potential point of interest or upon detecting that the user is interacting with an application that accesses point of interest data, providing a notice to the user that providing the point of interest data set will be free or providing a notice to the user that providing a point of interest data set may provide a reward.

14. A computer-readable storage medium storing computer-executable instructions that when executed by a computer control the computer to perform a method, the method comprising:
receiving a point of interest data set from a user of a mobile device, where the point of interest data set is computer data suitable for storage on a computer-readable storage medium, where the point of interest data set includes information concerning a hyperlocal point of interest or a traditional point of interest, where the information concerning the hyperlocal point of interest includes information concerning transient attributes of the hyperlocal point of interest, and where the information concerning the traditional point of interest includes information concerning fixed attributes of the traditional point of interest, and where the point of interest data set includes an identifier of the user, where the identifier is configured to identify the user as a voluntarily registered participant in a rewards program or as a member of a social network correlated to the rewards program and to provide access to a profile of the user;
establishing a quality measure for the point of interest data set, where establishing the quality measure includes evaluating a completeness of the point of interest data set, evaluating a type of data provided in the point of interest data set, examining a profile of the user, evaluating a similarity of the point of interest data set to a previously acquired data set, or evaluating subsequent treatment of the point of interest data set;
selecting a reward to provide to the user as a function of an attribute of the point of interest data set, the quality measure, and an attribute of the user, where the reward is a cellular data reward, a data plan reward, a gaming reward, a shopping reward, a marketplace reward, a downloadable content award, or an affinity reward;
selectively providing the reward to the user or to a rewardee identified by the user, and
upon detecting that the user is at a potential point of interest or upon detecting that the user is interacting with an application that accesses point of interest data, providing a notice to the user that providing the point of interest data set will be free or providing a notice to the user that providing the point of interest data set may provide a reward.

15. An apparatus, comprising:
a processor;
a memory;
a set of logics configured to reward a user for making a contribution of user generated content to a crowd-sourced database; and
an interface to connect the processor, the memory, and the set of logics;
the set of logics comprising:
a first logic configured to acquire the contribution from the user, where the contribution is data produced by a mobile device, the data being suitable for storage on a computer-readable storage medium;
a second logic configured to produce an evaluation of the contribution; and
a third logic configured to provide a reward based on the contribution, the evaluation, and the user.

16. The apparatus of claim 15, the first logic being configured to acquire the contribution as data concerning a transient point of interest or a fixed point of interest, where the data concerning the transient point of interest includes a location of the transient point of interest and an activity associated with the transient point of interest, and where the data concerning the fixed point of interest includes a name and an address of the fixed point of interest.

17. The apparatus of claim 16, the second logic being configured to produce the evaluation of the contribution based on the completeness of the contribution, the timeliness of the contribution, the contents of the contribution, and the similarity of the contribution to an existing contribution.

18. The apparatus of claim 17, the third logic being configured to provide the reward based on the evaluation of the contribution and a profile of the user.

19. The apparatus of claim 18, the third logic being configured to update the profile of the user based on confirmation or repudiation of the contribution.

20. The apparatus of claim 16, comprising a fourth logic configured to notify the user that making a contribution is free and to notify the user that making a contribution may generate a reward.
